(19) United States
(12) Patent Application Publication
(10) Pub. No.: US 2025/0025959 A1
(43) Pub. Date: Jan. 23, 2025

(54) LASER WELDING METHOD, DEVICE, METAL BIPOLAR PLATE, HYDROGEN FUEL CELL, AND VEHICLE

(71) Applicant: Robert Bosch GmbH, Stuttgart (DE)

(72) Inventors: Wei Zhang, Suzhou (CN); Yunfei Che, Suzhou (CN); Guixiang Xiao, Suzhou (CN); Shulong Fang, Suzhou (CN)

(21) Appl. No.: 18/764,561

(22) Filed: Jul. 5, 2024

(30) Foreign Application Priority Data
Jul. 17, 2023 (CN) 2023 1087 7892.2

(51) Int. Cl. B23K 26/08; B23K 26/00; B23K 101/00

(52) U.S. Cl. CPC B23K 26/08; B23K 26/0006; B23K 2101/00

(57) ABSTRACT

A laser welding method, a device, a metal bipolar plate, a hydrogen fuel cell, and a vehicle are disclosed. The laser welding method is used for a metal bipolar plate of a hydrogen fuel cell, the metal bipolar plate being preset with a weld path, the weld path including a weld starting point and a weld end point. The laser welding method including (S1) applying and moving a laser beam along the weld path from the weld starting point, (S2) judging whether the movement distance of the laser beam reaches a movement distance threshold, and if yes, performing step S3, and (S3) reducing the movement speed of the laser beam and simultaneously reducing or maintaining the laser power of the laser beam.

This application claims priority under 35 U.S.C. § 119 to patent application no. CN 2023 1087 7892.2, filed on Jul. 17, 2023 in China, the disclosure of which is incorporated herein by reference in its entirety.

The present disclosure relates to the field of laser welding of metal bipolar plates, in particular, to laser welding methods, devices, metal bipolar plates, hydrogen fuel cells, and vehicles.

### BACKGROUND

A bipolar plate is an important part of a hydrogen fuel cell, which can collect current and distribute gas. The bipolar plate is divided into two main parts, namely, a cathodic plate and an anodic plate. Both are coupled together by welding to form a surrounding sealed channel and a cooling channel in the middle. The bipolar plate has very high sealing properties. If the leak is caused by poor sealing, the battery performance may degrade or the battery may lose its function. Currently, bipolar plates are connected primarily by laser welding. Laser welding primarily illuminates the metal surface with a laser beam, rapidly transferring heat from an upper plate to a lower plate after melting, forming a melt pool and curing to form a weld. A laser-welded bipolar plate is divided into three regions: a hydrogen region, an air region, and a cooling water region, where the cooling water region is an activation region.

During laser welding in the activation region, due to the small size of the region to be welded and the high temperatures in the welding process, it is easy to have poor thermal control at the end of a section of the weld path. If the heat input is too high, the metal plate can easily burn and form a perforation. If the heat input is too low, it may result in weak or incomplete welds.

For such laser welding, all welds are required to be well shaped and have small thermal deformation. However, the problem is in the quality of the welds: welds have leakage and welding defects, the surface of the weld is not smooth and is not aesthetically pleasing, the weld slag is seriously sputtered and the weld is not continuous; and the weld after welding is severely deformed, and the overall polar plate bulges.

### SUMMARY

According to different aspects, an object of the present disclosure is to address or alleviate the defects mentioned in the background art, particularly to avoid the risk of perforations of the metal bipolar plate that may be resulted from the welding process.

In addition, the present disclosure is also intended to solve or alleviate other technical problems present in the prior art.

The present disclosure solves the above-mentioned problems by providing a laser welding method, a device, a metal bipolar plate, a hydrogen fuel cell, and a vehicle. In particular, according to one aspect of the present disclosure, it provides:
a laser welding method for a metal bipolar plate of a hydrogen fuel cell, the metal bipolar plate being preset with a weld path that includes a weld starting point and a weld end point, wherein the laser welding method comprises the following steps:
S1: applying and moving a laser beam along the weld path from the weld starting point,
S2: judging whether a movement distance of the laser beam reaches a movement distance threshold, and if yes, performing Step S3;
S3: reducing a movement speed of the laser beam and simultaneously reducing a laser power of the laser beam or maintaining the laser power.

According to another aspect of the present disclosure, the present disclosure provides a computer readable storage medium having a computer program stored thereon, wherein any one of the above described laser welding methods is implemented when the computer program is executed by a processor.

According to yet another aspect of the present disclosure, the present disclosure provides a computer device comprising a memory, a processor, and a computer program stored on the memory and operable on the processor, wherein the processor implements any one of the above described laser welding methods when executing the computer program.

According to yet another aspect of the present disclosure, the present disclosure provides a laser welding device for a metal bipolar plate of a hydrogen fuel cell, the metal bipolar plate being preset with a weld path, the weld path including a weld starting point and a weld end point, wherein the laser welding device is used to perform any one of the above laser welding methods, the laser welding device including a laser and a judgment module, the laser being configured to be capable of applying and moving a laser beam along the weld path from the weld starting point, the judgement module being configured to judge whether a movement distance of the laser beam reaches a movement distance threshold, and if yes, cause the laser to reduce a movement speed of the laser beam and simultaneously reduce a laser power of the laser beam or maintain the laser power.

According to a further aspect of the present disclosure, the present disclosure provides a metal bipolar plate of a hydrogen fuel cell, wherein the metal bipolar plate is welded by any one of the laser welding methods described above.

According to a further aspect of the present disclosure, the present disclosure provides a hydrogen fuel cell, wherein the hydrogen fuel cell has any one of the metal bipolar plates described above.

According to a further aspect of the present disclosure, the present disclosure provides a vehicle, wherein the vehicle has the hydrogen fuel cell described above.

### BRIEF DESCRIPTION OF THE DRAWINGS

Referring to the figures, the above-described and other features of the present disclosure will become apparent, wherein,

FIG. 1 shows a flow diagram of a laser welding method according to the present disclosure;

FIG. 2 shows a structural schematic view of a metal bipolar plate according to the present disclosure;

FIG. 3 shows a weld parameter curve and a weld path diagram corresponding to each other of a laser welding method according to the present disclosure;

FIG. 4 shows a laser power graph of another laser welding method according to the present disclosure;

FIG. 5 shows a laser movement speed graph of another laser welding method according to the present disclosure;

FIG. 6 shows an example of application of a laser welding method according to the present disclosure; and

FIG. 7 shows a schematic diagram of a structural module of a laser welding device according to the present disclosure.

### DETAILED DESCRIPTION

It will be readily understood that according to the technical solution of the present disclosure, without changing the spirit of the present disclosure, one of ordinary skill in the art may propose a variety of structural modes and implementations that are mutually replaceable. Therefore, the following specific embodiments and attached drawings are only exemplary descriptions of the technical solutions of the present disclosure, and shall not be considered as all of the present disclosure or as a limitation or restriction of the technical solutions of the present disclosure.

The terms up, down, left, right, front, back, front, rear, top, bottom, and the like mentioned or possibly mentioned in the Specification are defined relative to the constructions shown in the accompanying drawings and are relative concepts, and therefore may vary accordingly depending on their different locations and different states of use. Therefore, these or other orientation terms should not be construed as limiting. Further, the terms “first”, “second”, “third” and the like, or similar expressions are used solely for the purpose of description and differentiation and are not to be understood as indicating or implying the relative importance of the respective member.

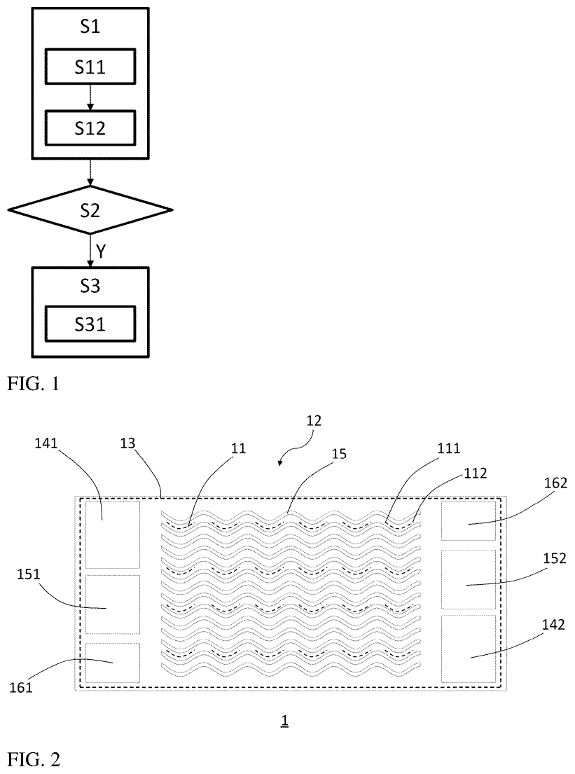

Referring to FIGS. 1 and 2, a flow schematic diagram of a laser welding method according to the present disclosure and a structural schematic diagram of a metal bipolar plate according to the present disclosure are shown, respectively. Of which, Y in the FIG. 1 represents Yes for a determination result.

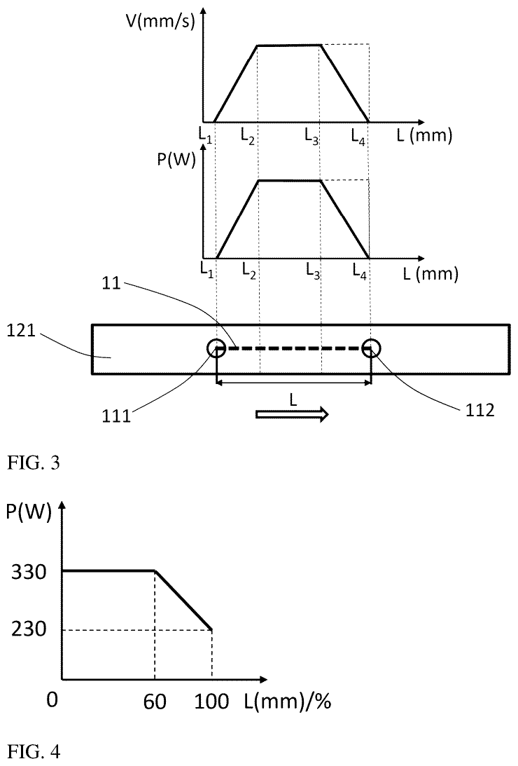

The laser welding method is used for a metal bipolar plate 1 of a hydrogen fuel cell, and the metal bipolar plate 1 is preset with a weld path 11 comprising a weld starting point 111 and a weld end point 112 (shown in FIG. 3), wherein the laser welding method comprises the following steps:
S1: applying and moving a laser beam 2 along the weld path 11 from the weld starting point 111,
S2: judging whether the movement distance of the laser beam 2 (shown in FIG. 6) reaches a movement distance threshold, and if yes, performing Step S3; if no, proceeding with step S1 to move the laser beam 2 along the weld path 11;
S3: reducing the movement speed of the laser beam 2 and simultaneously reducing or maintaining the laser power of the laser beam 2.

First, it should be noted that the naming of the various method steps herein is for the purpose of differentiation and ease of reference only, and does not mean that there is necessarily a sequence difference in the method steps (unless explicitly stated). The implementation sequence of the method steps can be adjusted according to the actual situation, or the method steps can even be implemented simultaneously.

Those skilled in the art should appreciate the conventional construction of the metal bipolar plate, such as shown in FIG. 2, which is configured with an air channel inlet 141, a coolant channel inlet 151, and a hydrogen channel inlet 161 from top to bottom on the left, and correspondingly a hydrogen channel outlet 162, a coolant channel outlet 152, and an air channel outlet 142 from top to bottom on the right, where cooling water can be used as the coolant. It should be understood that each channel can be segregated from each other so as not to affect each other. For example, the above-mentioned requirements can be achieved by providing a fuel gas channel or hydrogen gas channel on an outward side of the anodic plate of the metal bipolar plate, and providing an oxidation gas channel or air channel on an outward side of the cathodic plate of the metal bipolar plate, and the sides of the anodic and cathodic plates facing each other collectively form a coolant channel 15. Of course, one skilled in the art may modify the structure of the metal bipolar plate according to actual requirements and application environments. Since the specific structure of the metal bipolar plate is not the focus of the present disclosure, no more elaboration is made herein.

However, it is to be noted that during the design of the metal bipolar plate, the weld path of the metal bipolar plate is preset to facilitate application of subsequent laser welding. In this regard, the preset weld path for the activation region (i.e., the coolant channel region) of the metal bipolar plate and the weld path for the sealing region 13 at an outer edge of the plate are exemplary and schematically indicated in FIG. 2. Here, each weld path of the activation region is represented by a 5-small-section cambered dashed line, respectively, with a shape that corresponds to the shape of the surrounding coolant channel section so that the weld process does not affect the coolant channel itself and simultaneously achieves a good connection effect. In contrast, the weld path of the sealing region is indicated by a rectangular frame. However, it is also to be understood that the weld path indicated by the rectangular frame may be continuous or disconnected in practice. Exemplarily, in connection with FIG. 6 (which illustrates an application example of a laser welding method according to the present disclosure, wherein the welding direction is exemplarily from the paper surface to the inside), it can be seen that the weld path 11 is provided at a groove 121 of the activation region 12 of the metal bipolar plate 1 and/or provided at the sealing region 13 of the metal bipolar plate 1. In particular, the adaptability of the present laser welding method can be highlighted given the generally lower thickness of the surface of the groove and the higher requirements for the welding process. Of course, one skilled in the art may flexibly adjust the weld path (e.g., number, shape, distribution position, size) according to actual requirements. For example, one skilled in the art may also design a weld path between different channels in order to more fully improve the connection firmness.

Further, it should be understood that the movement speed of the laser beam described herein, or similar expression, refers to the speed at which a laser beam is moved by a device (e.g., a laser or a laser head) for emitting laser, rather than the speed of propagation of the laser beam in a medium. The laser weld may be a continuous laser or a pulsed laser. According to the above technical solution, by reducing the movement speed of the laser upon and after reaching a moving distance, the weld width can be increased to adapt to the gap, such that the thermal input caused by the laser is stable or not increased, avoiding the defects or risks of perforations, and reducing the thermal deformation of the metal bipolar plate, thereby achieving the purpose of the present disclosure. At the same time, the laser power of the laser beam 2 may be reduced or the laser power may be maintained, and this can be specifically determined based on actual needs or by experiments. Specific examples are also provided below. That is, the present method enables synergistic adjustment of power and speed to dynamically control the weld thermal input.

FIG. 3 shows a weld parameter curve and a weld path diagram corresponding to each other of a laser welding method according to the present disclosure.

As can be seen from FIG. 3, in Step S3, the movement speed of the laser beam 2 and the laser power of the laser beam 2 decrease linearly with the laser movement distance. When the laser beam 2 reaches the weld end point 112, the movement speed of the laser beam 2 is a third speed, and the laser power of the laser beam 2 is a third power. It should be understood that the change in the linear approach can be achieved more simply and the desired effects can still be achieved, resulting in a higher cost-effective rate. Step S3 herein simultaneously reduces the movement speed and power of the laser beam, thereby better balancing the purposes of weld widening and perforation prevention.

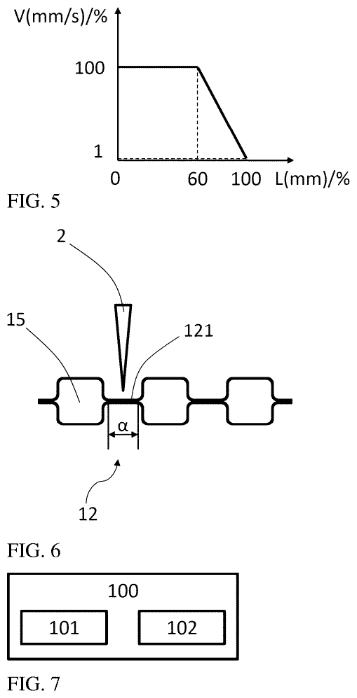

Further, in conjunction with FIGS. 4 and 5, a laser power graph of another laser welding method according to the present disclosure and a laser movement speed graph of another laser welding method according to the present disclosure are shown, respectively.

On the weld path 11, a first section (i.e., L₁ to L₂ indicated in the drawing), a second section (i.e., L₂ to L₃ indicated in the drawing), and a third section (i.e., L₃ to L₄ indicated in the drawing) connected in this order are divided from the weld starting point 111 to the weld end point 112,
Step S1 includes the following steps:
S11: in the first road segment, setting the movement speed of the laser beam 2 to increase from a first speed to a second speed or remaining the second speed, and setting the laser power of the laser beam 2 to increase from a first power to a second power or remaining the second power,
S12: in the second section, maintaining the second speed as the movement speed of the laser beam 2 and maintaining the second power as the laser power of the laser beam 2;
the third section corresponds to a section from a movement distance threshold to the weld end point 112 and Step S3 includes the following steps:
S31: reducing the movement speed of the laser beam 2 from the second speed to a third speed and reducing the laser power of the laser beam 2 from the second power to a third power.

It can be seen that FIGS. 3 to 5 give two different specific examples of laser welding. The overall idea remains to reduce the speed of movement of the laser beam after the movement of the laser reaches a certain threshold. These two examples specifically illustrate how laser power and laser speed may vary with the laser movement distance, or the laser application time. Exemplarily, in Step S11, the increase in the movement speed of the laser beam 2 is linear with the laser movement distance, and the increase in the laser power of the laser beam 2 is linear with the laser movement distance. Those skilled in the art may naturally determine other modes of change based on actual needs or experiments, such as changing the linear change to a parabolic linear change, adjusting the value of extreme points, and adding or deleting the number of extreme points.

Here, the dashed line and right arrow at the bottom of FIG. 3 exemplarily represent the weld path and the weld direction. Of course, as already described above, the weld path may take other shapes, such as cambers, curvilinear shapes, curved lines, and the like, and may be continuous or have breakpoints. As such, where the weld path is non-linear, the weld distance, or laser movement distance, is the distance actually swept by the laser or a straight line length after the weld path has been converted (e.g., by way of calculus) into a straight line, rather than simply a two-point straight line distance between the starting point and the end point. As can be seen from the drawings, L₃ represents the movement distance threshold referenced herein. The movement distance threshold may be set to 50% to 90% of the total length of the weld path 11, such as 60%, in order to achieve a reduction in laser movement speed, and simultaneous adjustment of laser power, if necessary, at a later stage of the welding process or at the end of the weld path. Through the various laser welding implementations so designed, laser speed is reduced, e.g., at the end of a welding wire, and the heat input is controlled, which helps inhibit defects generated during welding. At the same time, the overall speed of the laser welding can be maintained at a high level, thus ensuring or improving processing efficiency.

With respect to the selection of specific parameters for laser welding, in some examples of the present disclosure, the laser welding method has one or more of the following features:
the first speed is 500 mm/s to 2000 mm/s, or 0 mm/s;
the first power is 300 W to 350 W (e.g., 330 W), or is 0 W;
the second speed is 500 mm/s to 2000 mm/s;
the second power is 300 W to 350 W (e.g., 330 W);
the third speed is 5 mm/s to 20 mm/s (i.e., 1% of the second speed), or 0 mm/s;
the third power is 200 W to 250 W (e.g. 230 W), or 0 W.

Those skilled in the art naturally know that it is possible to reasonably select from the various parameters described above and combine the parameters, and it is possible to exclude combinations of clearly conflicting parameters.

It should be particularly mentioned that the first speed, especially the second speed, can reach 500 mm/s to 2000 mm/s (or may be set at 700 to 1000 mm/s). Therefore, the present method can be better applied to high-speed laser welding application scenarios, can greatly increase the laser movement speed of 100 mm/s in the prior art, can greatly shorten the welding cycle of metal bipolar plates, and improve the stability of the welding process and welding effect. It should be understood that not only the maximum speed, but also the average speed, or the median speed, of the present laser welding method can also reach 500 mm/s to 2000 mm/s as needed. Therefore, it can still be a high-speed laser welding process as a whole with high efficiency. Likewise, one skilled in the art is able to determine or adjust the values of various parameters or increase or reduce various parameters according to actual needs, application scenarios (e.g., actual weld path forms), or experiments. It can be seen that the present method overcomes the risk of perforations under high-speed welding and the defects of long production cycles under low-speed welding, and can achieve stable welding effect without perforations and with short cycles. In particular, it has features of good shape at a high welding speed, excellent mechanical performance and no leakage (lateral and vertical), and solves the bottleneck problem of weld leakage of bipolar plates of fuel cells at a high welding speed.

According to other aspects of the present disclosure, the present disclosure further relates to a computer readable storage medium having a computer program stored thereon, wherein, when executed by a processor, the computer program implements any one of the above-described laser welding methods; and the present disclosure relates to a computer device comprising a memory, a processor, and a computer program stored on the memory and operable on the processor, wherein the processor implements any one of the above-described laser welding methods when executing the computer program.

It will be understood that the computer readable storage medium and the computer device have all of the technical effects of the aforementioned laser welding methods and are not repeated here. The computer device may include control devices formed by various electronic devices. It will also be understood by one skilled in the art that the present disclosure implements all or part of the process of the laser welding method by directing related hardware through a computer program that can be stored in a computer readable storage medium, and that, when executed by a processor, can implement the steps of the various method examples described above. Here, the computer program comprises a computer program code, which may be understood to include, but is not limited to, a program code that executes the laser welding methods described above. For ease of illustration, only the portions relevant to the present disclosure are shown. The computer program code may be in the form of a source code, an object code form, an executable file, or certain intermediate forms, etc. The computer readable storage medium may comprise: any entity or device, medium, USB, mobile hard disk, magnetic disk, optical disk, computer memory, read only memory, random access memory, electrical carrier signal, telecommunication signal, software distribution medium, etc. that is capable of carrying the computer program code. It is to be noted that the content contained in the computer readable storage medium may be subject to appropriate additions or deletions as required by legislation and patent practice in certain jurisdictions. For example, in certain jurisdictions, the computer readable storage medium does not include an electrical carrier signal and a telecommunication signal in accordance with legislation and patent practice.

Referring to FIG. 7, a schematic diagram of a structural module of a laser welding device according to the present disclosure is shown.

Here, since the specific shape and connection of the various components are not the subject of the present disclosure, for clarity and simplicity, all of these components are schematically shown in the form of structural modules, and those skilled in the art may choose an appropriate form and connection mode of the modules themselves as inspired by the structural diagram. In addition, the structural diagram given is an example of the present disclosure, and those skilled in the art may make various modifications that do not deviate from the spirit of the present disclosure after reference to the simplified drawings. These modifications shall also fall within the protective scope of the present disclosure.

Accordingly, the present disclosure also provides a laser welding device 100 for a metal bipolar plate 1 of a hydrogen fuel cell, the metal bipolar plate 1 being preset with a weld path 11, the weld path 11 including a weld starting point 111 and a weld end point 112, wherein the laser welding device 100 is used to perform any one of the laser welding methods described above, the laser welding device 100 including a laser 101 and a judgment module 102, the laser 101 being configured to be capable of applying and moving a laser beam 2 along the weld path 11 from the weld starting point 111, the judgement module 102 being configured to judge whether a movement distance of the laser beam 2 reaches a movement distance threshold, and if yes, cause the laser 101 to reduce a movement speed of the laser beam 2 and simultaneously reduce a laser power of the laser beam 2 or maintain the laser power. The present disclosure also provides a metal bipolar plate 1 of a hydrogen fuel cell, wherein the metal bipolar plate 1 is welded by any one of the above laser welding methods.

Similarly, with regard to the various examples of the laser welding device and metal bipolar plate and the technical effects that can be achieved, please refer to the foregoing interpretations of the laser welding methods, and no further description is provided here. It is to be noted, however, that the metal bipolar plate 1 may have one or more of the following features:
the thickness of the metal bipolar plate 1 is less than 0.1 mm (e.g., 0.075 mm);
the material of the metal bipolar plate 1 is selected from one or more of stainless steel, aluminum alloy, and titanium alloy;
the width α of the groove 121 of the activation region 12 of the metal bipolar plate 1 (shown in FIG. 6) is less than 2 mm (e.g., 0.3 mm).

It can be seen that the various technical solutions described herein are well suited to metal bipolar plates that typically have small thickness and small groove width, such that the grooves can be connected effectively, and those skilled in the art can specifically select any one of the three metal materials described above or composite materials composed therefrom, thus having a good adaptability in a more stringent application scenario. The parameters can also be flexibly adjusted based on actual needs or experiments. Of course, each technical solution may also be applicable to metal bipolar plates having other plate thicknesses (e.g., 0.3 mm) or groove sizes.

Finally, the present disclosure also provides a hydrogen fuel cell, wherein the hydrogen fuel cell has any one of the metal bipolar plates 1 described above; and also provides a vehicle, wherein the vehicle has the hydrogen fuel cell described above.

Please also refer to the foregoing for an explanation of the examples and effects of these two topics. Here, the vehicle may include any vehicle carrying a hydrogen fuel cell, such as a car, a van, a bus, and an electric vehicle.

In summary, the present disclosure can achieve a high welding speed (500 mm/s to 2000 mm/s). After welding, the bipolar plate is well shaped, flat and hardly deformed, and the two bipolar plates are connected securely after welding without perforation, so that the leakage of bipolar plates is avoided and the welding efficiency is improved.

It should be understood that all of the above preferred examples are exemplary and non-limiting, and various modifications or variations made by those skilled in the art to the specific examples described above under the concept of the present disclosure shall be within the scope of legal protection of the present disclosure.

What is claimed is:

1. A laser welding method for a metal bipolar plate of a hydrogen fuel cell, the metal bipolar plate being preset with a weld path, the weld path including a weld starting point and a weld end point, the laser welding method comprising:
(S1) applying and moving a laser beam along the weld path from the weld starting point;
(S2) judging whether a movement distance of the laser beam reaches a movement distance threshold, and
(S3) if the movement distance of the laser beam reaches the movement distance threshold, reducing a movement speed of the laser beam and simultaneously reducing a laser power of the laser beam or maintaining the laser power.

2. The laser welding method according to claim 1, wherein in the step (S3), the movement speed of the laser beam and the laser power of the laser beam are all reduced linearly with the laser movement distance, and when the laser beam reaches the weld end point, the movement speed of the laser beam is a third speed, and the laser power of the laser beam is a third power.

3. The laser welding method according to claim 1, wherein:
on the weld path, a first section, a second section, and a third section connected in this order are divided from the weld starting point to the weld end point,
the step (S1) includes the following steps:
(S11) in the first section, setting the movement speed of the laser beam to increase from a first speed to a second speed or remaining the second speed, and setting the laser power of the laser beam to increase from a first power to a second power or remaining the second power, and
(S12) in the second section, maintaining the second speed as the movement speed of the laser beam and maintaining the second power as the laser power of the laser beam, and
the third section corresponds to a section from the movement distance threshold to the weld end point and the step (S3) includes the following:
(S31) reducing the movement speed of the laser beam from the second speed to a third speed and reducing the laser power of the laser beam from the second power to a third power.

4. The laser welding method according to claim 1, wherein the movement distance threshold is set to 50% to 90% of a total length of the weld path.

5. The laser welding method according to claim 3, wherein in the step (S11), an increase in the movement speed of the laser beam is linear with the laser movement distance, and an increase in the laser power of the laser beam is linear with the laser movement distance.

6. The laser welding method according to claim 1, wherein the weld path is disposed at a groove of an activation region of the metal bipolar plate and/or disposed at a sealing region of the metal bipolar plate.

7. The laser welding method according to claim 3, wherein the laser welding method has one or more of the following features:
the first speed is 500 mm/s to 2000 mm/s, or 0 mm/s;
the first power is 300 W to 350 W, or 0 W;
the second speed is 500 mm/s to 2000 mm/s;
the second power is 300 W to 350 W;
the third speed is 5 mm/s to 20 mm/s, or 0 mm/s;
the third power is 200 W to 250 W, or 0 W.

8. A computer readable storage medium having a computer program stored thereon, wherein the laser welding method according to claim 1 is implemented when the computer program is executed by a processor.

9. A computer device comprising a memory, a processor, and a computer program stored on the memory and operable on the processor, wherein the processor implements the laser welding method according to claim 1 when executing the computer program.

10. A laser welding device for a metal bipolar plate of a hydrogen fuel cell, the metal bipolar plate being preset with a weld path, the weld path including a weld starting point and a weld end point, wherein the laser welding device is used to perform the laser welding method according to claim 1, the laser welding device including a laser and a judgment module, the laser being configured to apply and move a laser beam along the weld path from the weld starting point, the judgement module being configured to judge whether a movement distance of the laser beam reaches a movement distance threshold, and if yes, cause the laser to reduce a movement speed of the laser beam and simultaneously reduce a laser power of the laser beam or maintain the laser power.

11. A metal bipolar plate of a hydrogen fuel cell, wherein the metal bipolar plate is welded by the laser welding method according to claim 1.

12. The metal bipolar plate according to claim 11, wherein the metal bipolar plate has one or more of the following features:
the metal bipolar plate has a thickness of less than 0.1 mm;
the metal bipolar plate has a material selected from one or more of stainless steel, aluminum alloy, and titanium alloy; and
the groove of the activation region of the metal bipolar plate has a width of less than 2 mm.

13. A hydrogen fuel cell having the metal bipolar plate according to claim 11.

14. A vehicle, wherein the vehicle has the hydrogen fuel cell according to claim 13.
